(19) United States
(12) Patent Application Publication
(10) Pub. No.: US 2006/0058977 A1
(43) Pub. Date: Mar. 16, 2006

(54) Method for monitoring tyre pressure variation of automobile tyre and system for realizing the same

(76) Inventor: Youcong Zhu, Guang Dong Province (CN)

Correspondence Address: WESTMAN CHAMPLIN & KELLY, P.A., SUITE 1400 - INTERNATIONAL CENTRE, 900 SECOND AVENUE SOUTH, MINNEAPOLIS, MN, 55402-3319, US

(21) Appl. No.: 10/940,482

(22) Filed: Sep. 14, 2004

(51) Int. Cl. G01P 3/00; G06F 15/00

(52) U.S. Cl. 702/148

(57) ABSTRACT

A method for monitoring tyre pressure variation of automobile tyres, comprising steps of: (1) obtaining rotation speeds of individual automobile tyres, and creating rotation speed reference values Vr for comparison and judgment based on the obtained rotation speeds; (2) obtaining current rotation speeds of individual automobile tyres, and comparing the values corresponding to the obtained current rotation speeds of individual tyres with the rotation speed reference values Vr of individual tyres; (3) judging the compared result of step (2), and raising an alarm if the compared result is beyond a preset value. (4) turning to step (2).

### FIELD OF THE PRESENT INVENTION

The present invention relates to a method and a system for detecting indirectly the tyre pressure variations of automobile tyre, more particularly, to a detection method and system for judging the tyre pressure variation by detecting rotation turns of the wheels, calculating rotation speeds of the wheels, comparing and analyzing these rotation speeds.

### DESCRIPTION OF THE RELATED ART

In prior art, pressure sensors are generally installed on the tyres for measuring tyre pressure of running vehicles and sending overpressure and underpressure alarms according to the measured tyre pressure. The main disadvantage of this direct measurement-type device is that the tyre pressure variations are large at different speeds, thus resulting in such problems that the critical value for tyre pressure alarm is difficult to set and facile error alarm may be raised. In addition, such device generally transfers signals in a mode of radio transmission and receiving, and this is easy to be effected by electromagnetic wave and magnetic field.

Theoretically, the tyre pressure variations will cause changes in the effective radius of the tyres and thus cause different rotation speeds of the tyres. Therefore, the tyre pressure variations can be forecasted by detecting the variations in the tyre rotation speed and alarms are raised in case of overpressure or underpressure. Such indirect measurement mode can, with using different rotation speeds at different speeds as its basis for judging overpressure or underpressure of the tyres, solve the problem of facile error alarm occurring in the direct measurement mode.

In fact, however, the effective radius of individual tyres of the motor vehicles are generally different form each other due to not only different brands but also different wearing degrees, and thus resulting in different rotation turns of individual tyres at the same speed. Therefore, there is still problem such as low accuracy of alarm in the method or system that establishes corresponding standards only in accordance with specifications of the tyres so as to suit different conditions for comparison and judgment. In addition, such method and system cannot determine the tyre pressure variations when the vehicle is turning and are also difficult to judge location of the fault tyre properly.

### SUMMARY OF INVENTION

An object of the present invention is to provide a monitoring method with high alarm accuracy, which can perform data sampling in accordance with current concrete conditions of individual tyres of the vehicle so as to establish a set of rotation speed data of the individual tyres, compare these data with the real-time measured or measured and calculated rotation speeds of individual tyres, forecast the tyre pressure variations and raise alarms in case of overpressure or underpressure.

An another object of the present invention is to provide a method by which the overpressure or underpressure of the tyre can be monitored when the vehicle is turning.

A further object of the present invention is to provide a monitoring method for determining and displaying correct location of a tyre in case of the overpressure or underpressure when an alarm is raised.

A further object of the present invention is to provide a monitoring system with high alarm accuracy, which can perform data sampling in accordance with current concrete conditions of individual tyres of a vehicle so as to establish a set of rotation speed data of individual tyres, compare these data with the real-time measured or measured and calculated rotation speeds of individual tyres, forecast the tyre pressure variation and raise alarms in case of overpressure or underpressure.

A further object of the present invention is to provide a system by which the overpressure or underpressure of the tyre can be monitored when the vehicle is turning.

A further object of the present invention is to provide a monitoring system for determining and displaying correct location of the tyre in case of the overpressure or underpressure when an alarm is raised.

The objects can be achieved by providing a method for monitoring tyre pressure variations of automobile tyre, comprising the following steps of:
(1) obtaining rotation speeds of individual automobile tyres, and creating rotation speed reference values Vr for comparison and judgment based on the obtained rotation speeds;
(2) obtaining current rotation speeds of individual automobile tyres, and comparing the values corresponding to the obtained current rotation speeds of individual tyres with said rotation speed reference values of individual tyres;
(3) judging the compared result of step (2), and raising an alarm if the compared result is beyond the preset value;
(4) turning to step (2).

The rotation speed reference values Vr mentioned in the step (1) do not change any longer after being obtained at the beginning unless they are obtained by restarting, and the step (2) can be considered as the first step when the inspection is carried out every time; said rotation speeds can be obtained directly by sensors, and also calculated through measurement of rotating turns and time; the comparison can be made by the difference method or the proportional method; the preset value can be reckoned and may be obtained through tests with higher accuracy.

In above method, the compared result in the step (3) is confirmed only when the difference between current rotation speeds obtained continuously many times and rotation speed reference value Vr is beyond the preset value.

Said word ‘continuously’ means that the comparison is carried out between adjacently measured or calculated rotation speeds. And the comparison may be referred as comparing corresponding rotation speeds or formulas including individual rotation speeds.

In above method, for the rotation speeds mentioned in the steps (1) and (2), the braking case or the tyre's turns measured during braking and the spent time must be excluded.

In above method, the comparison in the step (2) is carried out in accordance with following method:
Reference rotation speed difference Vd=|(Vtlf−Vtrf)−(Vtlb−Vtrb)|;
Measured and calculated rotation speed difference Vc=|(Vclf−Vcrf)−(Vclb−Vcrb)|; And,
Regarding Vres=|Vd−Vc| as the compared result;
Wherein, Vtlf, Vtrf, Vtlb and Vtrb represent the teaching values of the measured rotation speeds of the left front tyre, the right front tyre, the left rear tyre and the right rear tyre, respectively, and Vclf, Vcrf, Vclb and Vcrb represent the current measured rotation speeds of the left front tyre, the right front tyre, the left rear tyre and the right rear tyre, respectively.

In above method, the following data will be calculated when an alarm is raised in the step (3):
Left difference reference of rotation speed Vrld=Vtlf−Vtlb;
Right difference reference of rotation speed Vrrd=Vtrf−Vtrb;
Left difference of measured and calculated rotation speed Vcld=Vclf−Vclb;
Right difference of measured and calculated rotation speed Vcrd=Vcrf−Vcrb;
And;
Comparing |Vrld−Vcld| with |Vrrd−Vcrd|:
If |Vrld−Vcld|>|Vrrd−Vcrd|, then further comparing Vclf with Vclb;
   If Vclf>Vclb, it is indicated that a fault occurs in the left front tyre;
   if Vclf<Vclb, it is indicated that a fault occurs in the left rear tyre;
If |Vrld-Vcld|<|Vrrd−Vcrd|, then further comparing Vcrf with Vcrb;
   If Vcrf>Vcrb, it is indicated that a fault occurs in the right front tyre;
   If Vcrf<Vcrb, it is indicated that a fault occurs in the right rear tyre.

A system for monitoring tyre pressure variation of automobile tyre, comprising a tyre signal interface circuit for obtaining rotation signal of vehicle tyres and converting the same; a braking signal converting circuit for obtaining braking signal of the vehicle and converting the same; a key-press input circuit; a single chip microprocessor, which performs processing in accordance with signals provided by the tyre signal interface circuit, the braking signal converting circuit and the key-press input circuit; a display screen interface circuit or a buzzer driving circuit, which sends concerned information to the display screen or the buzzer based on processing results of the single chip microprocessor, wherein the single chip microprocessor performs process in accordance with flowing procedures:
(1) obtaining the rotation speeds of individual automobile tyres, and creating rotation speed reference values Vr for comparison and judgment based on the obtained rotation speeds;
(2) obtaining current rotation speeds of individual automobile tyres, and comparing the values corresponding to the obtained current rotation speeds of individual tyres with said rotation speed reference values Vr of individual tyres;
(3) judging the compared result of step (2), and raising an alarm if the compared result is beyond the preset value; (4) turning to step (2).

Said rotation speeds can be obtained directly by sensors, or calculated through measurement of rotating turns and time; the comparison can be made by the difference method or the proportional method; the preset value can be reckoned and may be obtained through tests with higher accuracy.

In above system, the compared result in the processing step (3) is confirmed only when the difference between current rotation speeds obtained continuously many times and rotation speed reference value Vr is beyond the preset value.

Said word ‘continuously’ means that the comparison is carried out between adjacently measured or calculated rotation speeds. And the comparison may be referred as comparing corresponding rotation speeds or formulas including individual rotation speeds.

The above system is also provided with data setting circuit, which can provide data concerning various type of vehicles to the single chip microprocessor so that the system forms preset values.

In above system, for the rotation speeds mentioned in the processing steps (1) and (2), the braking case or the tyre's turns measured during braking and the spent time must be excluded.

In above system, the comparison in the processing step (2) is carried out in accordance with following method:
Reference rotation speed difference Vd=|(Vtlf−Vtrf)−(Vtlb−Vtrb
Measured and calculated rotation speed difference Vc=|(Vclf−Vcrf)−(Vclb−Vcrb)|; And,
Regarding Vres=|Vd−Vc| as the compared result;
Wherein, Vtlf, Vtrf, Vtlb and Vtrb represent the teaching values of the measured rotation speeds of the left front tyre, the right front tyre, the left rear tyre and the right rear tyre, respectively, and Vclf, Vcrf, Vclb and Vcrb represent the current measured rotation speeds of the left front tyre, the right front tyre, the left rear tyre and the right rear tyre, respectively.

In above system, the following data will be calculated if an alarm is raised in the step (3):
Left difference reference of rotation speed Vrld=Vtlf−Vtlb;
Right difference reference of rotation speed Vrrd=Vtrf−Vtrb;
Left difference of measured and calculated rotation speed Vcld=Vclf−Vclb;
Right difference of measured and calculated rotation speed Vcrd=Vcrf−Vcrb;
And;
Comparing|Vrld−Vcld| with|Vrrd−Vcrd|:
If |Vrld−Vcldl>lVrrd−Vcrd|, then further comparing Vclf with Vclb;
   If Vclf>Vclb, it is indicated that a fault occurs in the left front tyre;
   if Vclf<Vclb, it is indicated that a fault occurs in the left rear tyre;
If |Vrld-Vcidl<|Vrrd-Vcrd|, then further comparing Vcrf with Vcrb;
   If Vcrf>Vcrb, it is indicated that a fault occurs in the right front tyre;
   If Vcrf<Vcrb, it is indicated that a fault occurs in the right rear tyre.

1. This method or system performs data sampling, measurement or calculation in accordance with concrete conditions of individual tyres of the vehicle so as to establish a set of rotation speed data of individual tyres, and compares these data with the real-time measured or calculated rotation speeds of individual tyres to forecast the tyre pressure variations so as to adapt to monitoring of the tyre pressure variations of various types of vehicles and to be closer to actual conditions of individual tyres. In such way, it solve deviation problem that results from different rotation speeds of individual tyres at the same speed which are caused by different effective radius due to different brands and different wearing degree for the same specification, thus effectively improving monitoring and alarming accuracies of the method or system.

2. The compared result is confirmed only when the absolute value of the difference between measured and calculated rotation speed difference Vc obtained continuously many times and reference rotation speed difference Vd is beyond the preset value, thus avoiding malfunction problem that may be caused by sudden and large variation in the data in such special cases as bumpy road during traveling.

3. During measuring and determining rotation speed, the braking case is specially treated and the impact caused by braking is removed, resulting in ensuring accuracy of the data, no impact on further measurement of the data, shortening measurement process and improving response ability.

4. The judgment compares differences between sums of rotation speeds or references on different sides. Therefore, the tyre pressure variations can still be monitored by such arithmetic when the vehicle is turning.

5. The correct location of the tyres in case of overpressure or underpressure can be indicated to help the driver take corresponding emergent measures on the basis of his or her experiences so as to avoid accident as far as possible, and also help people find fault and problems as soon as possible so as to maintain and replace defective one(s).

6. This method or system also plays role in such case that two or three tyres are in fault at the same time.

7. This method or system only requires obtaining rotation speeds or rotating turns and braking signals of individual tyres of the vehicle, which can be obtained at the driver's location. Therefore, this method or system is of simple one and is easy and convenient to be equipped with system.

8. Compared with other method or system, the present invention is featured by no impact caused by radio signal and magnetic field.

### BRIEF DESCRIPTION OF THE DRAWINGS

The foregoing and other objects, features and advantages of the present invention will become more readily apparent from the following detailed description of the preferred embodiments of the present invention in conjunction with the accompanying drawings of which:

FIG. 1 is a block diagram of method procedures and system software of the embodiment of the present invention;

FIG. 2 is a block diagram of the FIG. 1-1 for determining the reference data;

FIG. 3 is a block diagram of the FIG. 1-1 for fault analysis;

FIG. 4 indicates the power circuit of the system according to an embodiment of the present invention;

FIG. 5 indicates the data setting circuit of the system according to an embodiment of the present invention;

FIG. 6 indicates the tyre signal interface circuit of the system according to an embodiment of the present invention;

FIG. 7 indicates the single chip microprocessor and braking signal converting circuit of the system according to an embodiment of the present invention;

FIG. 8 indicates the key-press input circuit, buzzer driving circuit, LCD display screen and its interface circuit of the system according to an embodiment of the present invention.

### DESCRIPTION OF THE PREFERRED EMBODIMENTS

The detailed embodiment mode of the system and method according to the present invention is further explained as follows combined with the attached drawings:

The step or procedure design of the embodiment is divided into two parts, i.e., reference rotation speed difference Vd establishment part and measured and calculated rotation speed difference Vc establishment part, and there are some common procedures between these two parts, so that they can be designed as another common part that mainly comprises measurement of rotating turns of individual tyres, inspection of data effectiveness and calculation of rotation speeds of individual tyres, and two parts are separated each other and enter individual substantial procedure after judging the teaching mark.

The establishment part of a reference value of rotation speed requires measuring and obtaining two sets of data, mainly comprising measurement of teaching values of individual tyres, inspection of effectiveness of teaching values, establishment of quasi-reference value Vrq and establishment of reference data so as to determine the reference value of the rotation speed Vr, and this process is called ‘teaching’ that establishes reference data for comparison and judgment.

The inspection part comprises these processes of comparison of the measured and calculated rotation speed difference Vc with the reference rotation speed difference Vd, inspection of speed overlimit, fault analysis, correction analysis and alarm display, etc.

The following contents give explanation of composition and functions of individual parts.

Measurement of the rotating turns of individual tyres. In this part, the rotating turns of individual tyres can be obtained from the sensor provided on the motor vehicle. In general, the vehicle is possible driven at a slow speed, so that the rotation speed shall not be evaluated on the basis of instantly measured data and it is required to evaluate based on the rotating turns in a certain period. More detailed, each measurement of the rotation speed shall be made with the rotating turns in a certain period as the calculation basis, and the measuring speed depends on the time necessary for measurement.

Inspection of data effectiveness. It is necessary to inspect the effectiveness of the actually measured rotating turns of the tyres. Whatever the establishment of the reference value or the inspection process it is, the data during the braking is not typical and is of no significance due to the great instant variation in the rotation speed, and so that it shall be excluded; in addition, the time during which the rotating turns are measured also must be excluded so as to ensure accuracy of the measured rotation speed. Specifically, it is necessary to judge whether there is braking currently during measuring rotating turns of the tyres, and if positive, the turns and the needed time in this measurement will not be accumulated into the total turns and total time.

Calculation of rotation speeds of individual tyres. The rotation speeds of individual tyres will be calculated after inspection of the data effectiveness in accordance with the measured rotating turns and the needed measurement time.

Measurement of teaching values of individual tyres. It is required to obtain these reference values of rotation speeds of the new tyres, the substituted tyres after being repaired or re-teaching of the system by calculating the rotation speeds of said individual tyres. The obtained reference value of rotation speed is referred as teaching values and will be used for calculating the reference values.

Inspection of effectiveness of the teaching values. The efficiency of the measured teaching values shall be inspected and the data is effective when meeting the following conditions: the vehicle's speed is more than 20 km/hour and less than 80 km/hour, and |Vtlf−Vtrf|≦0.34 turns/s and |Vtlb−Vtrb|≦0.34 turns/s. Wherein, Vtlf, Vtrf, Vtlb and Vtrb represent the teaching values of the measured rotation speeds of the left front tyre, the right front tyre, the left rear tyre and the right rear tyre, respectively, and Vclf, Vcrf, Vclb and Vcrb represent the current measured rotation speeds of the left front tyre, the right front tyre, the left rear tyre and the right rear tyre, respectively. The vehicle's speed is 2×π×R×N, wherein R is the general radius of the tyres, N is the rotating speed of the tyre, π is the circular constant which is preset as 3.14.

Determination of quasi-reference values Vrq. Six sets of teaching values which are proved effective through above effectiveness inspection of the teaching values are obtained (six times) and their absolute values are calculated as following respectively: |(Vtlf−Vtrf)−(Vtlb−Vtrb)|, and one set of the largest absolute value and one set of the smallest absolute value are discarded, and the average rotating speeds of individual tyres are calculated respectively from the rest four sets of studied values as the quasi-reference values Vrq.

Determination of reference data. Based on determination of the quasi-reference value Vrq=|(Vtlf−Vtrf−(Vtlb−Vtrb)|, the quasi-reference value Vrq₁ and the quasi-reference value Vrq₂ are obtained. If |Vrq₂−Vrq₁≦27×10⁻⁹ turns/s, these two values will be used for calculating the mean rotating speeds of individual tyres as the rotation speed reference value Vr, namely, Vr=(Vrq₁+Vrq₂)/2; if |Vrq₂−Vrq₁|>27×10⁻⁹ turns/s, the quasi-reference value Vrq₃ will be determined again, and then compared with the quasi-reference value Vrq₂. By analogy, until |Vrqₙ−Vrqₙ−|≦27×10⁻⁹ turns/s (wherein, Vrqₙ, Vrqₙ₋₁ are the last two quasi-reference value) and then the mean of the last two quasi-reference values Vrqₙ, Vrqₙ₋₁ is regarded as the rotation speed reference value Vr.

Comparing measured and calculated rotation speed difference Vc with reference rotation speed difference Vd. The measured and calculated rotation speed difference Vc and reference rotation speed difference Vd of the left front tyre, the right front tyre, the left backtyre and the right rear tyre are calculated and compared detailedly as follows:
Reference rotation speed difference Vd=|(Vtlf−Vtrf)−(Vtlb−Vtrb)|;
Measured and calculated rotation speed difference Vc=|(Vclf−Vcrf)−(Vclb−Vcrb)|; And regarding Vres=|Vd−Vc| as the compared result.

If the compared result Vres≦1112×10⁻⁹ turns/s, it is considered that the rotation speed is normal, otherwise the rotation speed is considered as being beyond the limit and there is possible fault in tyres. Wherein, Vclf, Vcrf, Vclb and Vcrb represent the current measured rotation speeds of the left front tyre, the right front tyre, the left rear tyre and the right rear tyre, respectively. Such arithmetic, because uses the rotation speed of the tyres on different sides for comparison, can overcome impact on the arithmetic caused by the naturally quick rotation speed of the tyres on the outer side when the vehicle is turning the corner, which can be counteracted in the calculation, and thus the arithmetic is still able to play a role in monitoring the tyres when the vehicle is turning the corner.

Inspection of speed over-limit. When the speed of the vehicle is less than 20 km/hour or more than 200 km/hour, it is regarded as going beyond the inspection scope and the inspection is not performed any longer, in which the vehicle's speed is 2×π×R×N, wherein R is the general radius of the tyres, N is the rotating speed of the tyre, π is the circular constant which is preset as 3.14.

Fault analysis. The first step is to separate the left side from the right side before comparison and judgment, and then to judge which side is in the fault and then which one between the front and the rear tyres is in fault, with detailed comparison and calculation as follows:
Left difference reference of rotation speed Vrld=Vtlf−Vtlb;
Right difference reference of rotation speed Vrrd=Vtrf−Vtrb;
Left difference of measured and calculated rotation speed Vcld=Vclf-Vclb;
Right difference of measured and calculated rotation speed Vcrd=Vcrf-Vcrb;
And;
Comparing |Vrld−Vcld| with |Vrrd−Vcrd|:
If |Vrld−Vcld|>|Vrrd−Vcrd|, then further comparing Vclf with Vclb;
   If Vclf>Vclb is three times continuously, it is indicated that a fault occurs in the left front tyre;
   if Vclf<Vclb is three times continuously, it is indicated that a fault occurs in the left rear tyre;
If |Vrld−Vcld|<|Vrrd−Vcrd|, then further comparing Vcrf with Vcrb;
   If Vcrf>Vcrb is three times continuously, it is indicated that a fault occurs in the right front tyre;
   If Vcrf<Vcrb is three times continuously, it is indicated that a fault occurs in the right rear tyre.

If the rotation speed is beyond the limit three times continuously, it is considered that the compared result is confirmed and fault occurs in tyres, and the limit is stipulated on this basis so that the malfunction problem that may be caused by large variation in the data in such special cases as bumpy road during traveling can be avoided.

The above-mentioned word ‘continuously’ means that the comparison is carried out between corresponding adjacently measured or calculated speeds.

Correction analysis. The system will perform automatic analysis after replacement of the tyre in the case of fault, and the alarm mark will be cleared if the compared result is not more than the preset value three times continuously.

Alarm display. In the case of fault, i.e., there is a fault mark, a sound alarm will be raised and the fault location of the tyre will be displayed to inform the user.

For the embodiment mode provided by the present invention, its method and system procedures can be organized into the following flow chart in accordance with above compositions:

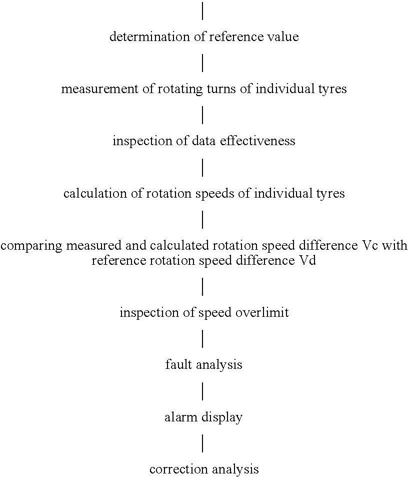

The embodiments of the present invention are given as follows and relates to the Honda car with the tyre's diameter (2R) of 63 cm.

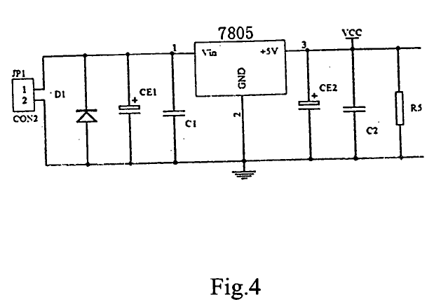

In the reference FIG. 4, the circuit is used for supplying DC power to the system, in which JP1 is connected to DC 9V-18V on the vehicle and the power is transformed into VCC (DC5V) voltage after filtered and stabilized. Diode D1 is used for preventing the input voltage from polarity inversion; R5 is a discharge resistor, by which the residual power on the electrolytic capacitor and other elements is discharged after power interruption in the circuit.

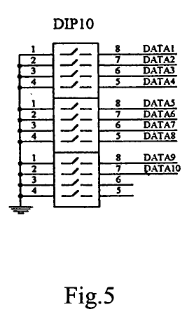

In the reference FIG. 5, the circuit is used for manual setting data in the single chip microprocessor, and also for adjusting 10-digit DIP switch of DIP10 in accordance with different models of the cars and different control requirements. The data of this embodiment is set on the basis of the variation of the effective radius of the tyre after 1 bar air pressure is released under the normal tyre pressure, and the default value of the system is 6 mm; the setting value of the DIP switch equals 2 if the actual variation is 8 mm; the setting value of the DIP switch equals −1 if the actual variation is 5 mm; in another word, the value of the DIP is set in accordance with the difference after comparison of the actual variation with the default value.

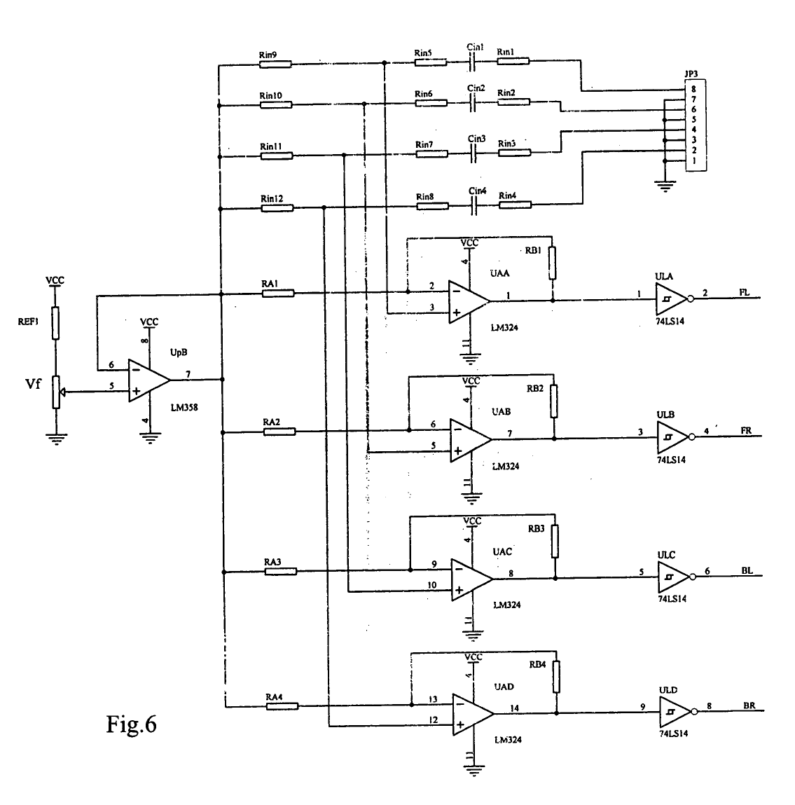

In the reference FIG. 6, the circuit is used for obtaining signals of four wheels and amplifying and transforming them, in which the connector JP3 is connected to the signals of four wheels; the signals, through the DC section in the Clin1, Clin2, Clin3 and Cin4 isolating signals, are amplified via Uaa, Uab, Uac and Uad, and shaped and filtered through 74LS14, and then transformed into the impulse signals FL, FR, BL and BR, which are connected to AT89S52, and Upb, through VF regulation, makes the Upb output voltage within the threshold.

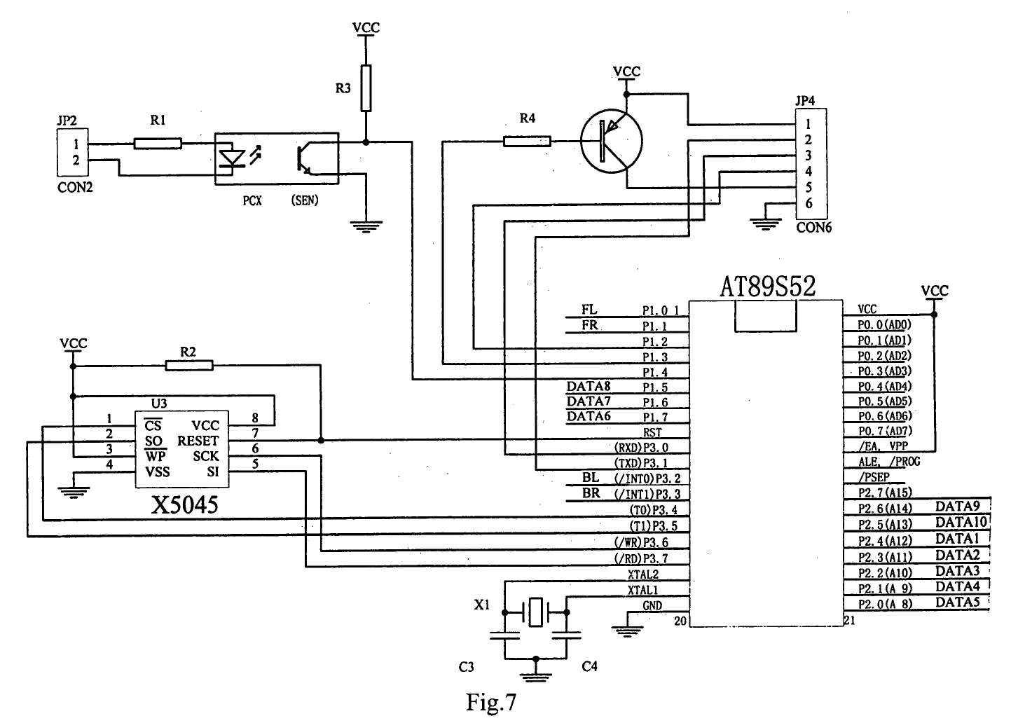

In the reference FIG. 7, the circuit is a central process part, in which P1.2 is used for inspecting whether the outside KEY is operated; P1.3 is used for controlling outside buzzer that gives out no sound for high level and gives out sound for low level; AT89S52 is connected to the processed signals FL, FR, BL and BR of four tyres; the connector JP2 is connected to the braking signal, and thus the status variation of P1.4 of AT89S52 can be determined immediately and outer interference to AT89S52 can be avoided through a PCX photoelectric coupler; P3.0 and P3.1 of AT89S52 can output different photoelectric effects in accordance with different outside unit (JP5 or JP7) connected to JP4; in addition, RST is connected to the RESET pin of X5045, and can reset AT89S52 in the case of power supplying and also low voltage of the circuit; P3.4, P3.5, P3.6 and P3.7 are connected to X5045 that supplies reset signal to AT89S52 and also can save the data into X5045 so that the data would not be lost during powering off and X5045 can function as a watchdog when the X5045 AT89S52 program is in malfunction.

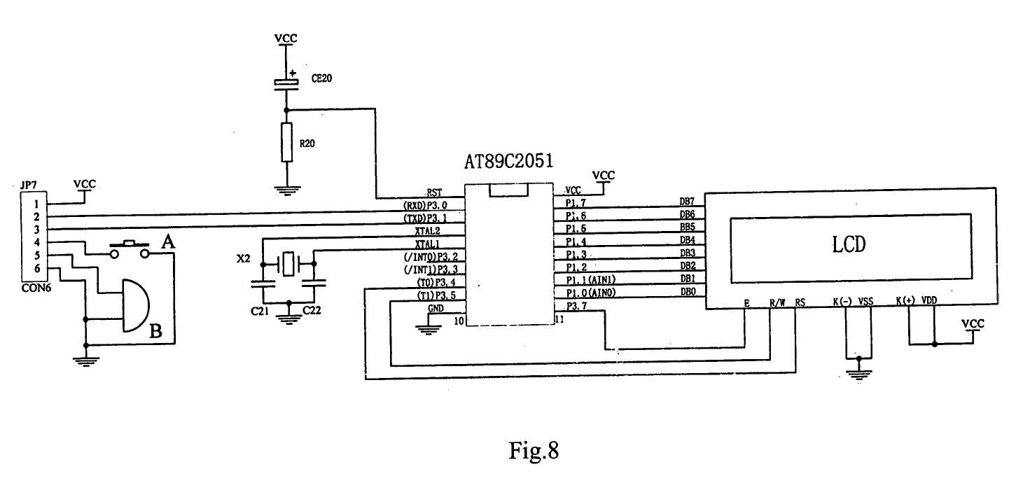

In the reference FIG. 8, the circuit comprises a key-press input circuit, a buzzer output circuit, a LCD display P-G14B32CP and its interface circuit; the connector JP7 is connected to the connector JP4; PIN1 and PIN6 are VCC and GND respectively; PIN2 and PIN3 are communication pins of AT89S52 and AT89C2051, in which the later receives data from the former, gives response and displays relevant information on the Chinese LCD; CE20 and R20 form a reset circuit which resets AT89C2051 during power supplying; X2, C21 and C22 form a oscillation circuit that provides AT89C2051 with time base; A is a teaching button and B is a buzzer.

The detailed method step or procedure flow of this embodiment is given as follows:

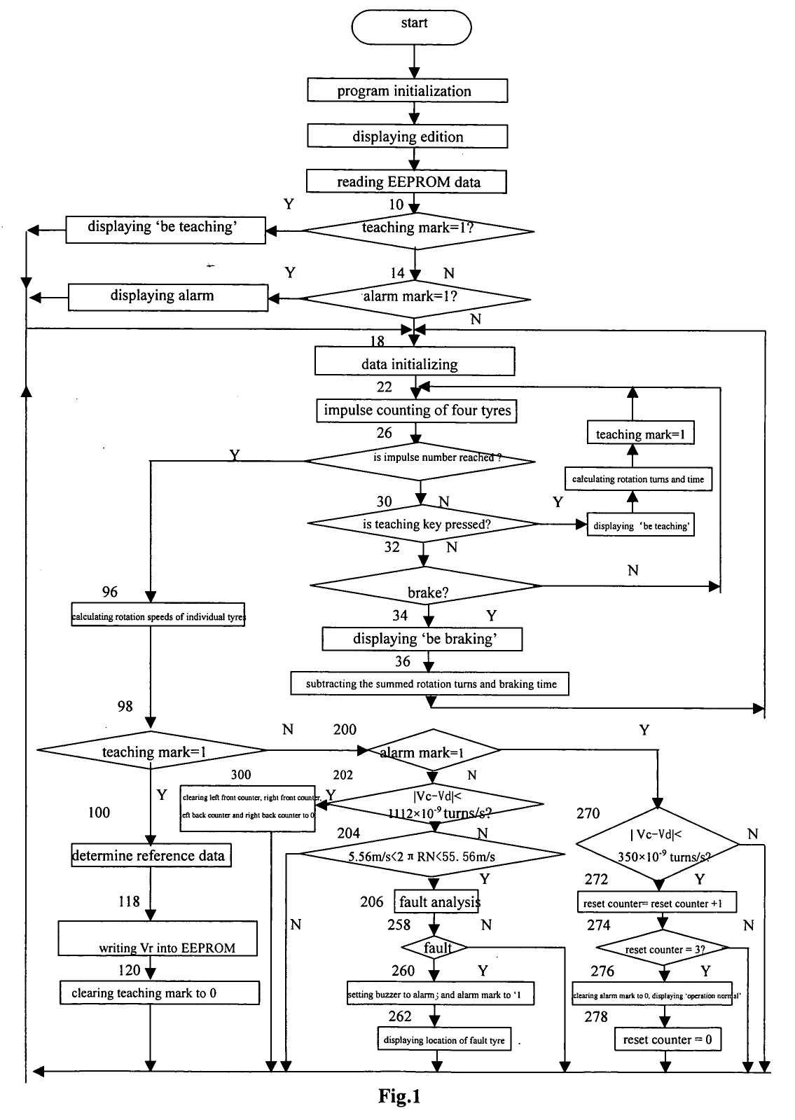

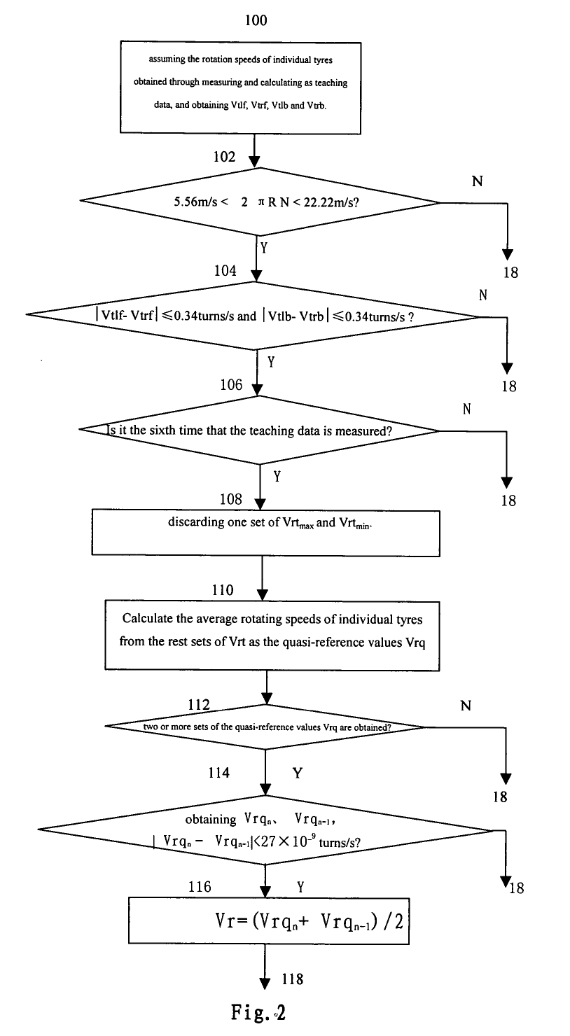

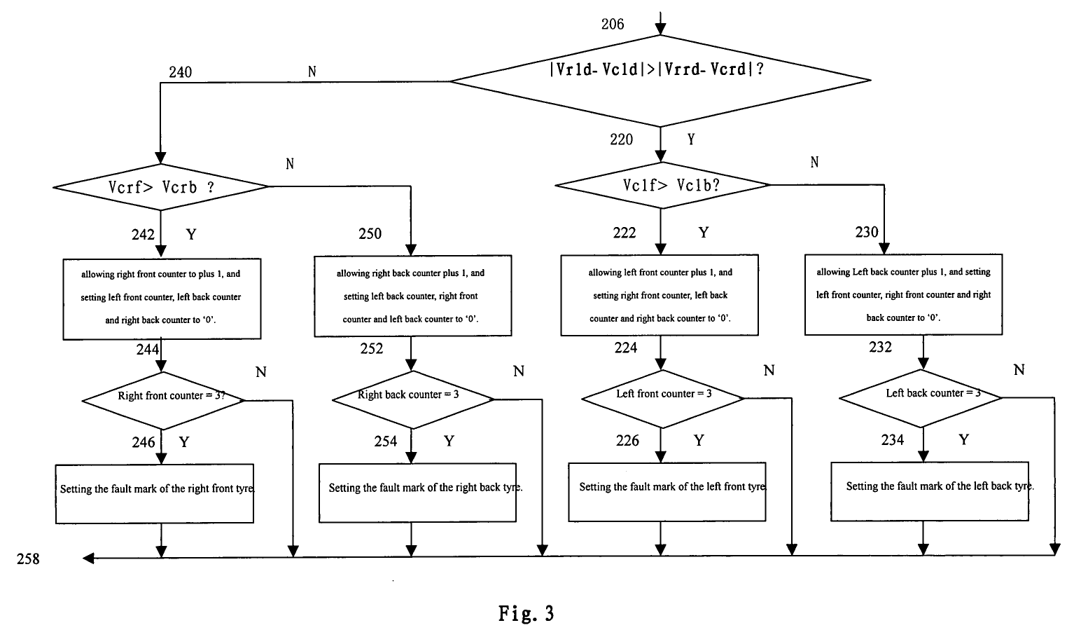

In the reference FIG. 1, FIG. 2 and FIG. 3, when starting, the program is initialized first to read data from EEPROM and makes process in following procedures:
1. In the step 10, judging whether the teaching mark is ‘1’, and if yes, displaying ‘be teaching ’, and turning to the step 18;
2. In the step 14, judging whether the alarm mark is ‘1’, and if yes, displaying ‘display alarm’, and turning to the step 18;

3. In the step 18, initializing the data, during which AT89C52 sets the read data to the circuit DIP10-digit value, and finds corresponding correction value in accordance with the following corresponding table of this difference:

| | | | | | | | | | | | | |
|---|---|---|---|---|---|---|---|---|---|---|---|---|
| Difference | −3 | −2 | −1 | 0 | +1 | +2 | +3 | +4 | +5 | +6 | +7 | +8 |
| Correction | −39 | −26 | −13 | 0 | 13 | 26 | 39 | 52 | 65 | 78 | 91 | 104 |
| value | | | | | | | | | | | | |

Where, the unit of the correction value is 10⁻⁹, and preset value=correction value+1112×10⁻⁹.
4. In the step 22, measuring rotating turns of individual tyres;
5. In the step 26, inspecting whether the rotating turns reach 300 turns, and if yes, turning to the step 96;
6. In the step 30, inspecting whether the teaching mark is pressed, and if yes, display ‘be teaching . . . ’, accumulate measured rotating turns, set the teaching mark to ‘1’ and turning to the step 22;
7. In the step 32, checking whether there is braking, and if not, turning to the step 22;
8. In the step 34, displaying ‘be braking . . . ’, and delay 1s;
9. In the step 36, judging whether it is in the teaching status, and if not, turning to the step 22 and if yes, turning to the step 18;
10. In the step 96, calculating rotation speeds of individual tyres;
11. In the step 98, judging whether it is in the teaching status, and if not, turning to the step 200;
12. In the step 100, assuming the rotation speeds of individual tyres calculated in the step 96 as teaching data;
13. In the step 102, checking whether the teaching values in the step 100 meet following requirement: 5.56 m/s<vehicle's speed<22.22 m/s; if not, turning to the step 18; in which the vehicle's speed is 2×π×R×N, wherein R is the general radius of the tyres, N is the rotating speed of the tyre, is the circular constant which is preset as 3.14.
14. In the step 104, checking whether the teaching values in the step 100 also meet following requirements:
   |Vtlf−Vtrf|≦0.34 turns/s and |Vtlb−Vtrb|≦0.34 turns/s, and if not, turning to the step 18;
15. In the step 106, judging whether it is the sixth time that the teaching data is obtained, and if not, turning to the step 18;
16. In the step 108, selecting and discarding one set of the largest value Vrtₘₐₓ and one set of the smallest value Vrtₘᵢₙ calculated from the following formula: Vrt=|(Vtlf−Vtrf)−(Vtlb−Vtrb)|;
17. In the step 110, calculating the average rotating speeds of individual tyres from the rest four sets of teaching values as the quasi-reference values Vrq;
18. In the step 112, judging whether two or more sets of the quasi-reference values Vrq are obtained, and if not, turning to the step 18;
19. In the step 114, judging whether|Vrqₙ−Vrqₙ₋₁| (wherein, Vrqₙ, Vrqₙ₋₁ are the last two quasi-reference value) is not more than 27×10⁻⁹ turns/s, and if not, turning to the step 18;
20. In the step 16, calculating the mean of the last two sets of the quasi-reference values Vrqₙ, Vrqₙ₋₁ as the rotation speed reference value Vr, namely, Vr=(Vrqn+Vrqₙ₋₁)/2;
21. In the step 118, writing the rotation speed reference value Vr into EEPROM;
22. In the step 120, setting the study mark to ‘0’ and turning to the step 18;
23. In the step 200, judging whether the alarm mark is ‘1’, and if yes, turning to the step 270;
24. In the step 202, calculate:
   Reference rotation speed difference Vd=|(Vtlf−Vtrf−(Vtlb−Vtrb)
   Measured and calculated rotation speed difference Vc=|(Vclf−Vcrf)−(Vclb−Vcrb)|; And regarding Vres=|Vd−Vc| as the compared result.

Judging whether|Vd−Vc| is less than 1112×10⁻⁹ turns/s, and if yes, turning to the step 300;
25. In the step 204, judging whether 5.56 m/s<2π×R×N<55.56 m/s, and if not, turning to the step 18; wherein R is the general radius of the tyres, N is the rotating speed of the tyre, π is the circular constant which is preset as 3.14;
26. In the step 206, calculating:
   Left difference reference of rotation speed Vrld=Vtlf−Vtlb;
   Right difference reference of rotation speed Vrrd=Vtrf−Vtrb;
   Left difference of measured and calculated rotation speed Vcld=Vclf−Vclb;
   Right difference of measured and calculated rotation speed Vcrd=Vcrf−Vcrb;
   and;
   Comparing|Vrld−Vcld| with |Vrrd−Vcrd|:
   If |Vrld−Vcld|<|Vrrd−Vcrd|, then turning to the step 240;
27. In the step 220, comparing Vclf with Vclb, and if Vclf<Vclb, turning to the step 230;
28. In the step 222, left front counter=left front counter+1, and setting all of right front counter, left back counter and right back counter to 0;
29. In the step 224, judging whether right front counter=3, and if not, turning to the step 258;
30. In the step 226, setting the fault mark of the left front tyre and turning to the step 258;
31. In the step 230, left back counter=left back counter+1, and setting all of left front counter, right front counter and right back meter to 0;
32. In the step 232, judging whether left back counter=3, and if not, turning to the step 258;
33. In the step 234, setting the fault mark of the left rear tyre and turning to the step 258;
34. In the step 240, comparing Vcrf with Vcrb, and if Vcrf<Vcrb, turning to the step 250;
35. In the step 242, right front counter=right front counter+1, and setting all of left front counter, left back counter and right back counter to 0;
36. In the step 244, judging whether right front counter=3, and if not, turning to the step 258;
37. In the step 246, setting the fault mark of the right front tyre and turning to the step 258;
38. In the step 250, right back counter=right back counter+1, and setting all of left front counter, right front counter and left back counter to 0;
39. In the step 252, judging whether right back counter=3, and if not, turning to the step 258;
40. In the step 254, setting the fault mark of the left rear tyre;
41. In the step 258, judging whether the fault marks are set, and if not, turning to the step 18;
42. In the step 260, setting the alarm mark to ‘1’, and the buzzer raises an alarm;
43. In the step 262, displaying location of fault tyre, and turning to the step 18;
44. In the step 270, if |Vd−Vc| is more than 250×10⁻⁹, turning to the step 18;
46. In the step 272, recovery counter=recovery counter+1;
47. In the step 274, judging whether recovery counter=3, and if not, turning to the step 18;
48. In the step 276, clearing the alarm mark to ‘0’, and displaying ‘operation normal’;
49. In the step 278, clearing the recovery counter to ‘0’, and turning to the step 18;
50. In the step 300, setting all of left front counter, right front counter, left back counter and right back counter as 0, and turning to the step 18;

In addition to above advantages and effects, the present invention has following advantages:
1. The rotation speed reference value is obtained through reference data sampling and determining method, and its value is typical and meets actual conditions and requirements and thereby is of standard significance.
2. The compared result is conformed under such condition that the rotation speeds of a tyre that are measured and calculated several times continuously are more than measured and calculated rotation speeds of other tyre, and in such way that the impact of individual tyres to each other can be avoided and the result is more accurate.
3. The preset value can be set by the switch through a data setting circuit, and there is simple variation in the system for different models of the vehicles, so that it is not necessary to change software.

In the context, in addition to meanings that are assigned directly, Vclf Vcrf, Vclb, Vcrb, Vtlf, Vtrf Vtlb Vtrb have following meanings:
Vclf, Vcrf, Vclb and Vcrb represent the current measured rotation speeds of the left front tyre, the right front tyre, the left rear tyre and the right rear tyre, respectively; and Vtlf, Vtrf, Vtlb and Vtrb represent the teaching values of the measured rotation speeds of the left front tyre, the right front tyre, the left rear tyre and the right rear tyre, respectively.

Although having described and illustrated a preferred embodiment of the present invention, it is understood by those skill in the art that the preferred embodiment of the present invention can be modified in arrangement and detail without departing from the principle and spirit of the present invention. We therefore claim all modifications and variations coming within the scope of the following claims and its equivalence.

1. A method for monitoring tyre pressure variation of automobile tyre, comprising steps of:
(1) obtaining rotation speeds of individual automobile tyres, and creating rotation speed reference values Vr for comparison and judgment based on the obtained rotation speeds;
(2) obtaining current rotation speeds of individual automobile tyres, and comparing the values corresponding to the obtained current rotation speeds of individual tyres with the rotation speed reference values Vr of individual tyres;
(3) judging the compared result of step (2), and raising an alarm if the compared result is beyond a preset value;
(4) turning to step (2).

2. The monitoring method according to claim 1, wherein the compared result in the step (3) is confirmed only when a difference between current rotation speeds obtained continuously many times and rotation speed reference value Vr is beyond the preset value.

3. The monitoring method according to claim 1, wherein for the rotation speeds mentioned in steps (1) and (2), a braking case or turns of tyre measured during braking and a spent time must be excluded.

4. The monitoring method according to claim 3, wherein the comparison in step (2) is carried out in accordance with following method:
Reference rotation speed difference Vd=|(Vtlf−Vtrf)−(Vtlb−Vtrb)|;
Measured and calculated rotation speed difference Vc=|(Vclf−Vcrf)−(Vclb−Vcrb)|; and,
Regarding Vres=|Vd−Vc| as the compared result;
Wherein, Vtlf, Vtrf, Vtlb and Vtrb represent teaching values of the measured rotation speeds of a left front tyre, a right front tyre, a left rear tyre and a right rear tyre, respectively, and Vclf, Vcrf, Vclb and Vcrb represent current measured rotation speeds of the left front tyre, the right front tyre, the left rear tyre and the right rear tyre, respectively.

5. The monitoring method according to claim 4, wherein the following data will be calculated if an alarm is raised in step (3):
Left difference reference of rotation speed Vrld=Vtlf−Vtlb;
Right difference reference of rotation speed Vrrd=Vtrf−Vtrb;
Left difference of measured and calculated rotation speed Vcld=Vclf−Vclb;
Right difference of measured and calculated rotation speed Vcrd=Vcrf−Vcrb;
and;
comparing |Vrld−Vcld| with |Vrrd−Vcrd|:
If |Vrld−Vcld|>|Vrrd−Vcrd|, then further comparing Vclf with Vclb;
If Vclf>Vclb, it is indicated that a fault occurs in the left front tyre;
if Vclf<Vclb, it is indicated that a fault occurs in the left rear tyre;
If |Vrld−Vcldl<|Vrrd−Vcrd|, then further comparing Vcrf with Vcrb;
If Vcrf>Vcrb, it is indicated that a fault occurs in the right front tyre;
If Vcrf<Vcrb, it is indicated that a fault occurs in the right rear tyre.

6. A monitoring method according to claim 3, wherein in step (1), rotation speed reference values of individual tyres are determined by means of a determining reference data method.

7. The monitoring method according to claim 6, wherein the comparison in step (2) is carried out in accordance with following method:
Reference rotation speed difference Vd=|(Vtlf−Vtrf)−(Vtlb−Vtrb)|;
Measured and calculated rotation speed difference Vc=|(Vclf−Vcrf)−(Vclb−Vcrb)|; And,
Regarding Vres=|Vd−Vc| as the compared result;
Wherein, Vtlf, Vtrf, Vtlb and Vtrb represent teaching values of the measured rotation speeds of the left front tyre, the right front tyre, the left rear tyre and the right rear tyre, respectively, and Vclf, Vcrf, Vclb and Vcrb represent the current measured rotation speeds of the left front tyre, the right front tyre, the left rear tyre and the right rear tyre, respectively.

8. The monitoring method according to claim 7, wherein the following data will be calculated if an alarm is raised in step (3):
Left difference reference of rotation speed Vrld=Vtlf−Vtlb;
Right difference reference of rotation speed Vrrd=Vtrf−Vtrb;
Left difference of measured and calculated rotation speed Vcld=Vclf−Vclb;
Right difference of measured and calculated rotation speed Vcrd=Vcrf−Vcrb;
And;
comparing |Vrld−Vcld| with |Vrrd−vcrd|:
if |Vrld−Vcld|>|Vrrd−Vcrd|, then further comparing Vclf with Vclb;
if Vclf>Vclb, it is indicated that a fault occurs in the left front tyre;
if Vclf<Vclb, it is indicated that a fault occurs in the left rear tyre;
if |Vrld−Vcld|<|Vrrd−Vcrd−|, then further comparing Vcrf with Vcrb;
if Vcrf>Vcrb, it is indicated that a fault occurs in the right front tyre;
if Vcrf<Vcrb, it is indicated that a fault occurs in the right rear tyre.

9. A system for monitoring tyre pressure variation of automobile tyre, comprising:
a tyre signal interface circuit for obtaining rotation signal of tyres of a vehicle and converting the same;
a braking signal converting circuit for obtaining braking signal of the vehicle and converting the same;
a key-press input circuit;
a single chip microprocessor, which performs processing in accordance with signals provided by the tyre signal interface circuit, the braking signal converting circuit and the key-press input circuit;
a display screen interface circuit or a buzzer driving circuit, which sends concerned information to the display screen or the buzzer based on processing results of the single chip microprocessor,
wherein the single chip microprocessor performs processing in accordance with flowing procedures:
(1) obtaining rotation speeds of individual automobile tyres, and creating rotation speed reference values Vr for comparison and judgment based on the obtained rotation speeds;
(2) obtaining current rotation speeds of individual automobile tyres, and comparing the values corresponding to the obtained current rotation speeds of individual tyres with the rotation speed reference values Vr of individual tyres;
(3) judging the compared result of step (2), and raising an alarm if the compared result is beyond a preset value;
(4) turning to step (2).

10. The monitoring system according to claim 9, wherein the compared result in step (3) is confirmed only when a difference between current rotation speeds obtained continuously many times and rotation speed reference value Vr is beyond the preset value.

11. The monitoring system according to claim 9, wherein for the rotation speeds mentioned in steps (1) and (2), a braking case or turns of tyre measured during braking and a spent time must be excluded.

12. The monitoring system according to claim 11, wherein the system is further provided with a data setting circuit.

13. The monitoring system according to claim 12, wherein the comparison in step (2) is carried out in accordance with following method:
Reference rotation speed difference Vd=|(Vtlf−Vtrf)−(Vtlb−Vtrb)|;
Measured and calculated rotation speed difference Vc=|(Vclf−Vcrf)−(Vclb−Vcrb)|; And,
Regarding Vres=|Vd−Vc| as the compared result;
Wherein, Vtlf, Vtrf, Vtlb and Vtrb represent teaching values of the measured rotation speeds of a left front tyre, a right front tyre, a left rear tyre and a right rear tyre, respectively, and Vclf, Vcrf, Vclb and Vcrb represent the current measured rotation speeds of the left front tyre, the right front tyre, the left rear tyre and the right rear tyre, respectively.

14. The monitoring method according to claim 13, wherein the following data will be calculated if an alarm is raised in step (3):
Left difference reference of rotation speed Vrld=Vtlf−Vtlb;
Right difference reference of rotation speed Vrrd=Vtrf−Vtrb;
Left difference of measured and calculated rotation speed Vcld=Vclf−Vclb;
Right difference of measured and calculated rotation speed Vcrd=Vcrf−Vcrb; And;
comparing |Vrld−Vcld| with |Vrrd−Vcrd|:
if |Vrld−Vcld|>|Vrrd−Vcrd|, then further comparing Vclf with Vclb;
if Vclf>Vclb, it is indicated that a fault occurs in the left front tyre;
if Vclf<Vclb, it is indicated that a fault occurs in the left rear tyre;
if |Vrld−Vcld|<|Vrrd−Vcrd|, then further comparing Vcrf with Vcrb;
if Vcrf>Vcrb, it is indicated that a fault occurs in the right front tyre;
if Vcrf<Vcrb, it is indicated that a fault occurs in the right rear tyre.

15. The monitoring method according to claim 11, wherein in step (1), the rotation speed reference values of individual tyres are determined by means of a determining reference data method.

16. The monitoring system according to claim 15, wherein the system is further provided with a data setting circuit.

17. The monitoring system according to claim 16, wherein the comparison in step (2) is carried out in accordance with following method:
Reference rotation speed difference Vd=|(Vtlf−Vtrf)−(Vtlb−Vtrb)|;
Measured and calculated rotation speed difference Vc=|(Vclf−Vcrf)−(Vclb−Vcrb)|; And,
Regarding Vres=|vd−Vc| as the compared result;
Wherein, Vtlf, Vtrf, Vtlb and Vtrb represent the teaching values of the measured rotation speeds of the left front tyre, the right front tyre, the left rear tyre and the right rear tyre, respectively, and Vclf, Vcrf, Vclb and Vcrb represent the current measured rotation speeds of the left front tyre, the right front tyre, the left rear tyre and the right rear tyre, respectively.

18. The monitoring method according to claim 17, wherein the following data will be calculated if an alarm is raised in step (3):
Left difference reference of rotation speed Vrld=Vtlf−Vtlb;
Right difference reference of rotation speed Vrrd=Vtrf−Vtrb;
Left difference of measured and calculated rotation speed Vcld=Vclf−Vclb;
Right difference of measured and calculated rotation speed Vcrd=Vcrf−Vcrb; And;
comparing |Vrld−Vcld| with |Vrrd−Vcrd|:
if |Vrld−Vcld|>|Vrrd−Vcrd|, then further comparing Vclf with Vclb;
if Vclf>Vclb, it is indicated that a fault occurs in the left front tyre;
if Vclf<Vclb, it is indicated that a fault occurs in the left rear tyre;
if |Vrld−Vcld|<| Vrrd−Vcrd|, then further comparing Vcrf with Vcrb;
if Vcrf>Vcrb, it is indicated that a fault occurs in the right front tyre;
if Vcrf<Vcrb, it is indicated that a fault occurs in the right rear tyre.

19. The monitoring system according to claim 11, wherein the comparison in step (2) is carried out in accordance with following method:
Reference rotation speed difference Vd=|(Vtlf−Vtrf)−(Vtlb−Vtrb)|;
Measured and calculated rotation speed difference Vc=|(Vclf−Vcrf)−(Vclb−Vcrb)|; and,
regarding Vres=|Vd−Vc| as the compared result;
wherein, Vtlf, Vtrf, Vtlb and Vtrb represent the teaching values of the measured rotation speeds of the left front tyre, the right front tyre, the left rear tyre and the right rear tyre, respectively, and Vclf, Vcrf, Vclb and Vcrb represent the current measured rotation speeds of the left front tyre, the right front tyre, the left rear tyre and the right rear tyre, respectively.

20. The monitoring method according to claim 19, wherein the following data will be calculated if an alarm is raised in step (3):
Left difference reference of rotation speed Vrld=Vtlf−Vtlb;
Right difference reference of rotation speed Vrrd=Vtrf−Vtrb;
Left difference of measured and calculated rotation speed Vcld=Vclf−Vclb;
Right difference of measured and calculated rotation speed Vcrd=Vcrf−Vcrb; and;
comparing |Vrld−Vcld| with |Vrrd−Vcrd|:
if |Vrld−Vcld|>|Vrrd−Vcrd|, then further comparing Vclf with Vclb;
if Vclf>Vclb, it is indicated that a fault occurs in the left front tyre;
if Vclf<Vclb, it is indicated that a fault occurs in the left rear tyre;
if|Vrld−Vcld|<|Vrrd−Vcrd|, then further comparing Vcrf with Vcrb;
if Vcrf>Vcrb, it is indicated that a fault occurs in the right front tyre;
if Vcrf<Vcrb, it is indicated that a fault occurs in the right rear tyre.
